(19) United States
(12) Patent Application Publication
(10) Pub. No.: US 2026/0131288 A1
(43) Pub. Date: May 14, 2026

(54) WATER PRODUCTION METHOD

(71) Applicant: TORAY INDUSTRIES, INC., Chuo-ku, Tokyo (JP)

(72) Inventors: Shigehisa HANADA, Otsu-shi, Shiga (JP); Masayuki HANAKAWA, Chuo-ku, Tokyo (JP); Shun SHIMURA, Otsu-shi, Shiga (JP)

(73) Assignee: TORAY INDUSTRIES, INC., Chuo-ku, Tokyo (JP)

(21) Appl. No.: 19/114,577

(22) PCT Filed: Sep. 7, 2023
(86) PCT No.: PCT/JP2023/032767

§ 371 Date: Mar. 24, 2025

(30) Foreign Application Priority Data
Sep. 26, 2022 (JP) 2022-152225

(51) Int. Cl. B01D 65/02; B01D 61/02; B01D 61/04; B01D 61/14; B01D 61/58; B01D 69/02; C02F 1/44; C02F 1/52; C02F 101/34; C02F 103/08

(52) U.S. Cl. CPC B01D 65/022; B01D 61/04; B01D 61/58; B01D 65/02; B01D 69/02; C02F 1/441; C02F 1/444; C02F 1/5245; B01D 61/025; B01D 61/145; B01D 61/147; B01D 2311/04; B01D 2317/025; B01D 2317/08; B01D 2321/04; B01D 2321/168; B01D 2321/185; B01D 2325/02832; B01D 2325/02833; B01D 2325/20; C02F 2101/34; C02F 2103/08; C02F 2303/16

(57) ABSTRACT

A water production method including: a membrane treatment step of treating a feed water for semipermeable membrane with a semipermeable membrane to separate the feed water for semipermeable membrane into a permeated water and a concentrated water; and at least one of the following steps (A) to (C): (A) a pretreatment step of obtaining the feed water for semipermeable membrane by pretreating a water-to-be-treated; (B) a cleaning step of cleaning the semipermeable membrane; and (C) a sterilizing agent addition step of adding a sterilizing agent to the semipermeable membrane, in which when a biopolymer concentration of the feedwater for semipermeable membrane exceeds 75 μgC/L, or when a biopolymer concentration of the concentrated water exceeds 75×1/(1−R) μgC/L, an operation condition of at least one of the pretreatment step, the cleaning step, and the sterilizing agent addition step is added or reinforced.

### CROSS REFERENCE TO RELATED APPLICATIONS

This application is the U.S. National Phase of PCT/JP2023/032767, filed Sep. 7, 2023, which claims priority to Japanese Patent Application No. 2022-152225, filed Sep. 26, 2022, the disclosures of these applications being incorporated herein by reference in their entireties for all purposes.

### FIELD OF THE INVENTION

The present invention relates to a water production method of obtaining fresh water by performing desalination of seawater, brackish water, or the like using a membrane, or obtaining recycled water by purifying sewage treatment water, industrial wastewater, or the like using a membrane.

### BACKGROUND OF THE INVENTION

A water production system using a semipermeable membrane is applied in many industries and water treatment fields including desalination of seawater, and is demonstrated to be superior in terms of separation performance, energy efficiency, and the like as compared with other separation methods. On the other hand, in the water production system, there is a problem that proliferation of microorganisms on a membrane surface or adhesion of a biological film (biofilm) to the membrane surface, that is, biofouling, causes a rapid increase in membrane differential pressure, resulting in a decrease in permeability and separability of the membrane.

It is general to clean the membrane in the case where the membrane differential pressure increases or the permeability and separability of the membrane decrease due to biofouling. Examples of a cleaning method include so-called flushing cleaning in which filtration is once stopped, raw water or a filtrated water is supplied to the membrane surface and clean the membrane surface, and chemical cleaning in which cleaning is performed using a cleaning agent. However, when the fouling progresses, even if the cleaning is performed, the membrane differential pressure, the permeability, and the separability do not completely recover, the frequency of cleaning gradually increases, the operation becomes impossible, and the membrane needs to be replaced. Therefore, it is important to inhibit the progress of fouling by cleaning the membrane at an appropriate stage before the fouling progresses.

As a method for inhibiting the progress of fouling, a large number of techniques of adding a chemical (hereinafter, referred to as “sterilizing agent”) for inhibiting proliferation of biofilms to water-to-be-treated have been proposed. If an addition concentration, frequency, time, and the like of these sterilizing agents are too low, the progress of fouling cannot be inhibited. On the other hand, if the addition concentration, frequency, time, and the like of these sterilizing agents are too high, the progress of fouling can be inhibited, but the chemical cost increases. Therefore, it is important to grasp conditions such as appropriate concentration, frequency, and time of addition of a sterilizing agent for inhibiting the progress of fouling.

When the water-to-be-treated is directly filtered through the semipermeable membrane in the case where the water-to-be-treated contains a component such as a suspended substance, an amount of the component adhering to the membrane surface increases, the differential pressure rapidly increases, and the operation becomes impossible. In order to avoid this, the raw water is pretreated and then supplied to the semipermeable membrane. However, operation conditions of the pretreatment step also affect the progress of fouling of the semipermeable membrane, and therefore, it is necessary to appropriately control the operation conditions of the pretreatment step in order to inhibit the progress of fouling of the semipermeable membrane.

Based on the above description, in order to inhibit the progress of fouling of the semipermeable membrane, it is important to appropriately evaluate the biofouling potential of the water-to-be-treated, and to appropriately control conditions of cleaning, addition of sterilizing agents, and the pretreatment step.

Patent Literature 1 and Patent Literature 2 disclose a method for performing membrane separation by focusing on a biopolymer contained as a part of an organic substance in water-to-be-treated, and adjusting an amount of the biopolymer in the water-to-be-treated to be equal to or less than a predetermined threshold, and the predetermined threshold is any value in a range of 9 ug/L or more and 12 ug/L or less, or 9 ug/L or more and 17 ug/L or less.

### PATENT LITERATURE

Patent Literature 1: JP6561082B
Patent Literature 2: JP6630689B

### SUMMARY OF THE INVENTION

However, in the technique of Patent Literature 1 and Patent Literature 2, a microfiltration membrane or an ultrafiltration membrane is assumed to be used in membrane separation, and is different from a fouling mechanism of the semipermeable membrane, and therefore it is difficult to apply the technique of Patent Literature 1 and Patent Literature 2 as it is. Further, the predetermined thresholds disclosed in these literatures are extremely low concentrations, and it is difficult to implement the predetermined threshold with water-to-be-treated such as general seawater and sewage treatment water.

Therefore, an object of the present invention is to provide a method for inhibiting progress of fouling of a semipermeable membrane in the case where fresh water is obtained by desalting seawater, brackish water, or the like using a membrane, or in the case where recycled water is obtained by purifying sewage treatment water, industrial wastewater, or the like.

As a result of intensive studies, the present inventors have found that the above problems can be solved by appropriately evaluating the biofouling potential of water-to-be-treated and appropriately controlling conditions of cleaning of a semipermeable membrane, addition of a sterilizing agent, and a pretreatment step, and have completed the present invention.

In order to solve the above problems, a water production method according to the present invention includes any of the following configurations.
(1) A water production method including:
a membrane treatment step of treating a feed water for semipermeable membrane with a semipermeable membrane to separate the feed water for semipermeable membrane into a permeated water and a concentrated water; and
at least one of the following steps (A) to (C):
(A) a pretreatment step of obtaining the feed water for semipermeable membrane by pretreating a water-to-be-treated;
(B) a cleaning step of cleaning the semipermeable membrane; and
(C) a sterilizing agent addition step of adding a sterilizing agent to the semipermeable membrane,
in which when a biopolymer concentration of the feed water for semipermeable membrane exceeds 75 μgC/L, or when a biopolymer concentration of the concentrated water exceeds 75×1/(1-R) μgC/L where R is a recovery rate of the permeated water in the membrane treatment step, an operation condition of at least one of the pretreatment step, the cleaning step, and the sterilizing agent addition step is added or reinforced.
(2) The water production method according to (1), in which in the pretreatment step, an operation condition of the pretreatment step is added or reinforced by adding a coagulant.
(3) The water production method according to (2), in which when the biopolymer concentration of the feed water for semipermeable membrane exceeds 75 μgC/L and is represented by P [μgC/L], ferric chloride is added as the coagulant at a concentration of (P-75)×0.1 [mg-Fe/L] or more and (P−75)×0.33 [mg-Fe/L] or less.
(4) The water production method according to any one of (1) to (3), in which the pretreatment step includes a microfiltration membrane method or an ultrafiltration membrane method.
(5) The water production method according to (4), in which an ultrafiltration membrane used in the ultrafiltration membrane method has a removal rate of dextran having a weight average molecular weight of 200,000 Da of 55% or more and 99% or less.
(6) The water production method according to (4) or (5), in which the ultrafiltration membrane used in the ultrafiltration membrane method has a removal rate of dextran having a weight average molecular weight of 40,000 Da of 60% or more and 95% or less.
(7) The water production method according to (5) or (6), in which the number of surface pores of the ultrafiltration membrane is 200 pores/μm² or more and 2000 pores/μm² or less.
(8) The water production method according to any one of (5) to (7), in which an average value of surface pore sizes of the ultrafiltration membrane is 5.0 nm or more and 12.0 nm or less.
(9) The water production method according to any one of (5) to (8), in which a value obtained by dividing the number of surface pores of the ultrafiltration membrane by the average value of surface pore sizes of the ultrafiltration membrane is 30 pores/μm²/nm or more and 100 pores/μm²/nm or less.
(10) A water production method including:
a membrane treatment step of treating a feed water for semipermeable membrane with a semipermeable membrane to separate the feed water for semipermeable membrane into a permeated water and a concentrated water; and
at least one of the following steps (A) to (C):
(A) a pretreatment step of obtaining the feed water for semipermeable membrane by pretreating a water-to-be-treated;
(B) a cleaning step of cleaning the semipermeable membrane; and
(C) a sterilizing agent addition step of adding a sterilizing agent to the semipermeable membrane,
in which when a filtration resistance increase degree (8A) at a time of filtrating the feed water for semipermeable membrane with an ultrafiltration membrane having a removal rate of dextran having a weight average molecular weight of 40,000 Da of 60% or more and 95% or less exceeds a predetermined threshold, an operation condition of at least one of the pretreatment step, the cleaning step, and the sterilizing agent addition step is added or reinforced.
(11) The water production method according to (10), in which the pretreatment step includes pretreating the water-to-be-treated using an ultrafiltration membrane having a removal rate of dextran having a weight average molecular weight of 40,000 Da of 60% or more and 95% or less, and the operation condition of at least one of the pretreatment step, the cleaning step, and the sterilizing agent addition step is added or reinforced when the filtration resistance increase degree (δA) when the feed water for semipermeable membrane flows back to the ultrafiltration membrane exceeds the predetermined threshold.

(12) The water production method according to (10) or (11), in which the threshold of the filtration resistance increase degree (δA) is 2.5×10⁻¹²/m².

According to the present invention, progress of fouling of a semipermeable membrane can be inhibited by appropriately controlling conditions of semipermeable membrane cleaning, sterilizing agent addition, and a pretreatment step.

### BRIEF DESCRIPTION OF THE DRAWINGS

FIG. 1 is a schematic diagram showing an example of a water production method of the present invention.

FIG. 2 is a schematic diagram showing a treatment method of a seawater desalination plant A.

FIG. 3 is a schematic diagram showing another treatment method of the seawater desalination plant A.

FIG. 4 is a schematic diagram showing a treatment method of a sewage reuse plant B.

FIG. 5 is a schematic diagram showing another example of the water production method of the present invention.

### DETAILED DESCRIPTION OF EMBODIMENTS OF THE INVENTION

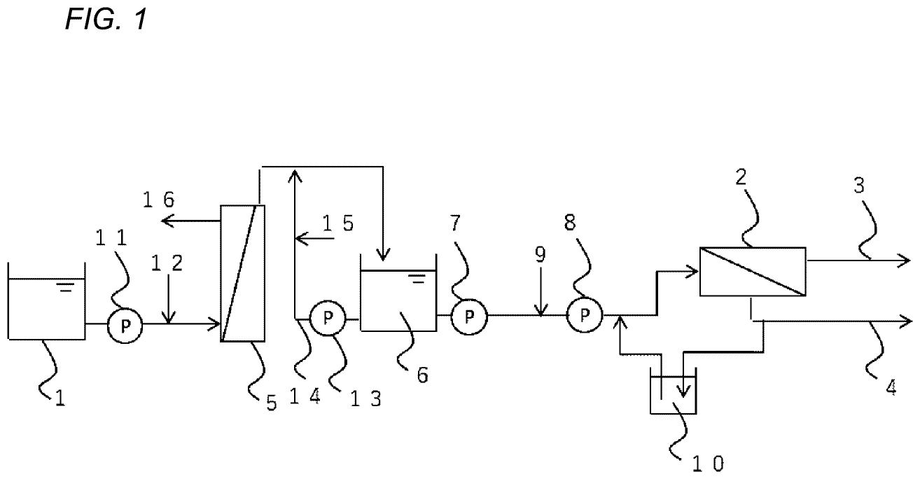

Hereinafter, the present invention will be described in detail with reference to FIG. 1, but the content of the present invention is not limited to the form of this figure.

In the present description, “mass” is synonymous with “weight”.

A water production method of the present invention is carried out in a water production system in which water-to-be-treated 1 is treated with a semipermeable membrane 2 and separated into permeated water 3 and concentrated water 4.

Examples of the water-to-be-treated include seawater, brackish water, river water, lake water, groundwater, sewage, and sewage secondary treatment water. When the water-to-be-treated is directly filtered with a semipermeable membrane in the case where the water-to-be-treated contains a solid component such as a suspended substance, an amount of solid components adhering to a membrane surface increases, a differential pressure rapidly increases, and the operation becomes impossible. Therefore, in this case, the water-to-be-treated is previously treated by a pretreatment unit 5 and then supplied to the semipermeable membrane.

The pretreatment method generally used is a coagulation and sand filtration method in which a coagulant is added to raw water to flocculate solid components, followed by filtration with sand, anthracite, or the like. On the other hand, this method is easily affected by variation in raw water and the quality of treated water is unstable, and therefore, a membrane pretreatment of performing treatment with a microfiltration membrane or an ultrafiltration membrane can also be adopted. In the case where raw water is organic wastewater such as sewage, in order to reduce organic substances contained in wastewater, pretreatment of performing solid-liquid separation can also be carried out to separate activated sludge after performing activated sludge treatment. A solid-liquid separation method may be precipitation separation using a commonly used precipitation tank, and a solid-liquid separation method using a separation membrane such as a microfiltration membrane or an ultrafiltration membrane can also be adopted for the purpose of improving the quality of treated water and the like.

The water-to-be-treated subjected to the pretreatment, that is, feed water for semipermeable membrane 6 is fed to a high-pressure pump 8 by a water feeding pump 7 and pressurized by the high-pressure pump 8, so that the pressurized water is supplied to the semipermeable membrane 2 at a pressure necessary for filtration and is separated into the permeated water 3 and the concentrated water 4. A sterilizing agent 9 for inhibiting the progress of biofouling in the semipermeable membrane may be added in the middle of a supply pipe. In order to control addition conditions of the sterilizing agent, a device for adding the sterilizing agent preferably includes a control mechanism having a valve and a pump capable of controlling an addition amount, addition time, an addition frequency, and the like.

A pipe line for introducing a cleaning agent 10 is provided upstream of the semipermeable membrane 2 for chemical cleaning. A point at which the cleaning agent is introduced is not particularly limited, and the downstream side thereof is preferable because the high-pressure pump 8 may be corroded depending on the type of the cleaning agent. Generally, the cleaning agent is led out from the middle of the pipe of the concentrated water 4 and circulated.

A membrane made of any material may be used as the semipermeable membrane as long as it can lower a salt concentration so that the water-to-be-treated can be used for drinking water, industrial water, city water, and the like, and examples thereof include membranes made of a cellulose acetate-based or polyamide-based material. Among them, a membrane made of the polyamide-based material is particularly effective in the method of the present invention. The polyamide-based membrane has a low resistance to chlorine that is most commonly used as a sterilizing agent in order to prevent proliferation of the biofilm, and even if chlorine has a slight concentration, membrane deterioration occurs significantly, and thus it is difficult to prevent biofouling. Therefore, the effect of carrying out the present invention is remarkable.

A water production method of the present invention performed by such a water production system includes:

a membrane treatment step of treating feed water for semipermeable membrane with a semipermeable membrane to separate the feed water for semipermeable membrane into permeated water and concentrated water; and
at least one of the following steps (A) to (C):
(A) a pretreatment step of obtaining the feed water for semipermeable membrane by pretreating water-to-be-treated;
(B) a cleaning step of cleaning the semipermeable membrane; and
(C) a sterilizing agent addition step of adding a sterilizing agent to the semipermeable membrane, in which
when a biopolymer concentration of the feed water for semipermeable membrane exceeds 75 μgC/L, or when a biopolymer concentration of the concentrated water exceeds 75×1/(1−R) μgC/L in which R is a recovery rate of the permeated water in the membrane treatment step, an operation condition of at least one of the pretreatment step, the cleaning step, and the sterilizing agent addition step is added or reinforced.

The biopolymer is a hydrophilic high molecular weight organic substance (polysaccharides, proteins, or the like) having a molecular weight of approximately 10 kDa to 20 kDa or more among organic substances. As the definition and measurement method of the biopolymer, the biopolymer can be measured by, for example, an organic carbon detection exclusion chromatography method (LC-OCD) as described in Huber, S. A., Balz, A, Abert, M., Pronk, W., 2011. Characterisation of aquatic humic and non-humic matter with size-exclusion chromatography e organic carbon detection e organic carbon detection e organic nitrogen detection (LC-OCD-OND). Water Research 45 (2), 879-885. Here, the LC-OCD method refers to an analysis method in which total organic carbon (TOC) components in a sample are fractionated for each molecular weight and represented as a chromatogram, and the retention time tends to be shorter for an organic substance having a larger molecular weight and hydrophilicity on the chromatogram. As measurement conditions of the LC-OCD method, conditions can be adopted in which a TSK HW50S of 250 mm×20 mm is used as a column, a flow rate is set to 1.1 mL/min, a sample injection amount is set to 1 mL, a UV wavelength is set to 254 nm, an amount of injecting an acid to a wet total organic carbon measuring instrument (OCD meter) is set to 0.2 mL/min, a phosphate buffer having a pH of 6.85 is used as an eluent, and a solution obtained by adding 4 mL of O-phosphoric acid (85%) and 0.5 g of potassium peroxodisulfate to 1 L ultrapure water as an acidic solution. As a measurement device used for the LC-OCD method, for example, an LC-OCD device (manufactured by DOC-Labar) having an OCD meter connected to high-performance liquid chromatography (HPLC) can be used.

In the present invention, the cleaning condition and/or sterilizing agent addition condition of the semipermeable membrane is added or reinforced when the biopolymer concentration of the feed water for semipermeable membrane measured by the above method exceeds 75 μgC/L. Here, examples of the cleaning condition include cleaning time, a cleaning frequency, and a cleaning method in the case of flushing cleaning, and include a type, a concentration, and an injection method of a cleaning agent, time, and a method in the case of chemical cleaning. For example, in the flushing cleaning, the high-pressure pump is temporarily stopped, the filtration is stopped, and only the water feeding pump is operated, so that a biofilm attached to the membrane surface is peeled, and cleaned and removed with the feed water for semipermeable membrane. Examples of a method for adding or reinforcing the cleaning include increasing the cleaning time and the cleaning frequency (also including carrying out cleaning methods that are not normally carried out), increasing the flow rate, repeating the increase and decrease thereof, and increasing the cleaning effect by flowing air or the like together.

In the chemical cleaning, the type of the cleaning agent is not particularly limited. In the case of biofouling, the cleaning is generally performed with an alkali, and examples of the cleaning agent include a 0.1% sodium hydroxide solution. The cleaning agent is generally placed in a cleaning tank or the like, introduced into an RO pipe from a downstream side of the high-pressure pump by a pump, led out from the middle of a concentrated water pipe, and circulated. As a cleaning method, for example, after circulating and cleaning were performed for about one hour (in some cases, repeated 2 times to 3 times), the semipermeable membrane is immersed for 2 hours to 24 hours, depending on the degree of fouling, and finally rinsed to complete the cleaning. Examples of a method for adding or reinforcing the cleaning include increasing the cleaning time and the cleaning frequency (also including carrying out cleaning methods that are not normally carried out), increasing the flow rate, repeating the increase and decrease thereof, and increasing the cleaning effect by flowing air or the like together.

Examples of the sterilizing agent addition conditions include the type, concentration, and injection method and time of the sterilizing agent. Examples of the type of the sterilizing agent include sterilizing agents containing 2-methyl-4-isothiazolin-3-one or 5-chloro-2-methyl-4-isothiazolin-3-one or salts thereof and mixtures thereof as active components, 2,2-dibromo-3-nitrilopropionamide (DBNPA), and sulfuric acid. As the concentration, for example, in the case of DBNPA, injection is performed such that the final concentration of the feed water for semipermeable membrane is 10 ppm, or in the case of sulfuric acid, injection is performed such that the pH of the feed water for semipermeable membrane is 3. As the injection method, continuous addition may be used, or intermittent addition, for example, adding once a day for one hour may be applied. The intermittent addition generally reduces the sterilizing agent cost. Examples of the method for adding or reinforcing the sterilizing agent addition condition include increasing the concentration, increasing the time, and increasing the frequency (also including carrying out the sterilizing agent addition condition that is not normally carried out).

The target water for measuring the biopolymer concentration may be concentrated water instead of the feed water for semipermeable membrane. In this case, the biopolymer is concentrated by the semipermeable membrane, and therefore, the cleaning condition and/or the sterilizing agent injecting condition of the semipermeable membrane is added or reinforced when the biopolymer concentration of the concentrated water exceeds 75×1/(1−R) μgC/L in which R is the recovery rate of the permeated water.

When the biopolymer concentration of the feed water for semipermeable membrane exceeds 75 μgC/L, the operation conditions of the pretreatment unit may be added or reinforced. As a method for adding or reinforcing the operation conditions, a method in which a coagulant is added to reduce the biopolymer is easiest to apply in terms of operation management. Specifically, it is efficient to add a coagulant in accordance with a concentration that is exceeded by the biopolymer concentration of the feed water for semipermeable membrane, and in the case where the biopolymer concentration of the feed water for semipermeable membrane is P [μgC/L], it is efficient and preferable to add ferric chloride as the coagulant at a concentration of (P−75)×0.1 [mg-Fe/L] or more and (P−75)×0.33 [mg-Fe/L] or less in terms of effectiveness and cost. (P−75) represents an excess from 75 μgC/L, and means addition at a concentration of 0.1 times or more and 0.33 times or less of this excess. Addition at a concentration of 0.1 times or more and 0.2 times or less of the excess of the biopolymer concentration is more efficient and preferable.

The pretreatment method is not particularly limited as long as it is a method capable of removing solid components such as suspended substances, such as the above-described coagulation and sand filtration method and membrane pretreatment method, and it is more preferable to adopt a membrane pretreatment method. In the case where the pretreatment method is the coagulation and sand filtration method, the coagulant addition concentration may be optimized to form flocs of suspended substance components in the water-to-be-treated, and when the coagulant addition concentration is increased to adjust the biopolymer concentration of the feed water for semipermeable membrane, the removal performance of the suspended substance components originally to be removed may be affected. On the other hand, in the case of the membrane pretreatment method such as a microfiltration membrane method or an ultrafiltration membrane method, removal of suspended substance components is achieved by the membrane pretreatment itself, and therefore, the suspended substance removal rate is always stable. In addition, it is not necessary to add a coagulant for the suspended substance components, and therefore, it is efficient because the coagulant may be added only in order to lower the biopolymer concentration only when the biopolymer concentration exceeds 75 μgC/L.

Examples of a method for increasing the biopolymer removal rate in the membrane pretreatment without adding a coagulant also include a method for increasing specific filtration resistance of the microfiltration membrane or the ultrafiltration membrane. This is a method for increasing the removal rate of the biopolymer by intentionally clogging the microfiltration membrane or the ultrafiltration membrane. The specific filtration resistance is represented by the following formula (1).

$${R}_{m} = ( TMP - {TMP}_{0} ) / ( μ \times J ) \qquad Formula ( 1 )$$

Here, Rₘ: specific filtration resistance [1/m], TMP: transmembrane differential pressure [Pa] during operation, TMP₀: initial transmembrane differential pressure [Pa], μ: viscosity coefficient [Pa·s] of water, and J: membrane filtration flux [m/s].

The operation of the microfiltration membrane or the ultrafiltration membrane is generally performed as follows. First, water-to-be-treated is supplied and filtered for a certain period of time (20 minutes to 30 minutes) with a predetermined membrane filtration flux. Thereafter, backflow cleaning using a filtrated water or air cleaning (physical cleaning) using a blower is performed for a certain period of time (30 seconds to 60 seconds), filtration is started again, and this cycle is repeated. In order to enhance the cleaning effect when backflow cleaning is performed, a chemical liquid such as an acid, an alkali, or sodium hypochlorite may also be injected (chemical liquid backflow cleaning). Examples of the method for increasing the specific filtration resistance by clogging the microfiltration membrane or the ultrafiltration membrane include increasing the membrane filtration flux, lengthening the filtration time (reducing the physical cleaning frequency), reducing the flow rate and time per physical cleaning, reducing the frequency of the chemical liquid backflow cleaning, and reducing the flow rate and time per chemical liquid backflow cleaning. When the removal rate of the biopolymer is increased by such a method, it is not necessary to add a coagulant, and therefore, the chemical cost can be reduced.

The ultrafiltration membrane preferably has a removal rate of dextran having a weight average molecular weight of 200,000 Da of 55% or more and 99% or less. The removal rate of dextran having a weight average molecular weight of 40,000 Da is more preferably 60% or more and 95% or less. The removal rate of dextran having a weight average molecular weight of 40,000 Da is more preferably 68% or more and 90% or less, and particularly preferably 70% or more and 90% or less. The biopolymer removal rate of the membrane itself is increased by using such a membrane, and therefore, the number of times that the biopolymer concentration in the feed water for semipermeable membrane exceeds 75 μgC/L is reduced or the concentration when the biopolymer concentration in the feed water for semipermeable membrane exceeds 75 μgC/L does not become so high. Therefore, not only operation control is easier, but also an amount of coagulant added is also reduced.

An aqueous dextran solution prepared to have a temperature of 25° C. and contain 1000 ppm of commercially available dextran is filtrated through the porous membrane at a cross-flow linear velocity of 1.0 m/sec and a transmembrane differential pressure of 10 kPa, and the dextran removal rate can be calculated using the following formula (2).

$$Dextran removal rate T ( \% ) = \{ ( refractive index of raw liquid ) - ( refractive index of permeated liquid ) \} / ( refractive index of raw liquid ) \times 100 \qquad Formula ( 2 )$$

Here, the cross-flow linear velocity is a value obtained by dividing a flow rate of the raw liquid to be filtrated in a direction perpendicular to a filtration direction by a cross-sectional area of a flow channel of the flow. The transmembrane differential pressure is a difference between a pressure on the filtration raw liquid side and a pressure on the permeated liquid side across the porous membrane.

In addition, for the ultrafiltration membrane, there is a trade-off relation between a high biopolymer removal rate and a filtration flux and a retention rate thereof. In order to maintain a high filtration flux while exhibiting a high biopolymer removal rate in the ultrafiltration membrane, the number of surface pores of the ultrafiltration membrane is preferably 200 pores/μm² or more and 2000 pores/μm² or less. Accordingly, the ultrafiltration membrane easily exhibits excellent fouling resistance and is preferable because the number of flow channels through which the filtration raw liquid passes through the ultrafiltration membrane can be sufficiently ensured even if fouling components in the filtration raw liquid partially block the surface pores of the ultrafiltration membrane as the filtration progresses. The number of surface pores of the ultrafiltration membrane is more preferably 290 pores/μm² or more and 1500 pores/μm² or less, and particularly preferably 350 pores/μm² or more and 1000 pores/μm² or less.

The number of surface pores of the ultrafiltration membrane is determined by binarizing an image obtained by observing a surface of the ultrafiltration membrane with an SEM using free software “ImageJ”. During binarization, after Create Background is performed by Subtract Background with 1 pixel, Condition: Renyi Entropy is selected in Threshold (threshold for binarization). The obtained binarized image can be analyzed by Analyze Particles to obtain an image. The number of surface pores is divided by an area of the analyzed image to obtain the number of pores per unit area. Similarly to the pore size, the number of surface pores is calculated by analyzing an image including one thousand or more pores.

In addition, an average value of the surface pore sizes of the ultrafiltration membrane is preferably 5.0 nm or more and 12.0 nm or less because coarse fouling substances (suspended substances) in the filtration raw liquid and biopolymers which are removal targets can be prevented from entering the ultrafiltration membrane, and high fouling resistance is easily exhibited. The average value of the surface pore sizes [nm] is more preferably 5.0 nm or more and 9.0 nm or less, and particularly preferably 5.0 nm or more and 8.0 nm or less.

The surface pore size is the size of pores present in the surface of the ultrafiltration membrane when the surface thereof is observed. In the case where the surface pore size of the ultrafiltration membrane is determined, the image obtained by observing the surface of the ultrafiltration membrane with the SEM is binarized using free software “ImageJ”. During binarization, after Create Background is performed by Subtract Background with 1 pixel, Condition: Renyi Entropy is selected in Threshold (threshold for binarization). In the obtained binarized images, an area of each pore is determined by selecting Area in Analyze Particles, and the diameter calculated on the assumption that each pore is a circle is defined as the surface pore size. When the average value of the surface pore sizes is determined, the pore sizes of one thousand or more pores are averaged to determine the average value.

When a value X obtained by dividing the number of surface pores of the ultrafiltration membrane by the average value of the surface pore sizes is 30 pores/μm²/nm or more and 100 pores/μm²/nm or less, a coarse substance (suspended substance) in the filtration raw liquid and biopolymers which are removal targets can be prevented from entering the ultrafiltration membrane, and the number of flow channels through which the filtration raw liquid passes through the ultrafiltration membrane can be sufficiently ensured, and therefore, the ultrafiltration membrane easily exhibits excellent fouling resistance and is preferable. A large X means that there are a large number of small pores. Generally, in the case where the pore size is small, the number of pores tends to be small, and the pore size and the number of pores are in a trade-off relation. As a result of intensive studies, the inventors have found that the ultrafiltration membrane exhibits excellent fouling resistance because coarse fouling substances (suspended substances) in the filtration raw liquid and biopolymers which are removal targets are prevented from entering the ultrafiltration membrane when the pores are small, and the number of flow channels through which the filtration raw liquid passes through the ultrafiltration membrane can be sufficiently ensured and the fouling components can be dispersed when the number of the pores is large. The number of pores and the pore size are in a correlative relation and both contribute to fouling resistance, and therefore, it is preferable to employ the X value in consideration of both as an index of fouling resistance. X of 30 pores/μm²/nm or more and 100 pores/μm²/nm or less is preferable because the ultrafiltration membrane used in the present invention has excellent fouling resistance, and X is more preferably 32 pores/μm²/nm or more and 80 pores/μm²/nm or less, and particularly preferably 50 pores/μm²/nm or more and 70 pores/μm²/nm or less.

Examples of the polymer serving as the material of the ultrafiltration membrane include polysulfone-based resins, polyethersulfone-based resins, polyvinylidene difluoride-based resins, nylons, cellulose esters such as cellulose acetate and cellulose acetate propionate, polymers of acrylic acid esters or methacrylic acid esters such as fatty acid vinyl esters, polyvinyl alcohol, polyvinyl acetate, polyvinylpyrrolidone, ethylene oxide, propylene oxide, and polymethyl methacrylate, and copolymers thereof.

In particular, in order to use the ultrafiltration membrane for long-term filtration, it is preferable to periodically perform chemical cleaning on accumulated fouling components, and the ultrafiltration membrane particularly preferably contains polyvinylidene difluoride-based resins having excellent chemical resistance. The polyvinylidene difluoride-based resin refers to a homopolymer of vinylidene fluoride or a copolymer of vinylidene fluoride. Here, the copolymer of vinylidene fluoride refers to a polymer having a vinylidene fluoride residue structure. The polymer having a vinylidene fluoride residue structure is typically a copolymer of a vinylidene fluoride monomer and other fluorine-based monomers or the like. Examples of such a fluorine-based monomer include vinyl fluoride, tetrafluoroethylene, hexafluoropropylene, and trifluorochloroethylene. In the copolymer of vinylidene fluoride, ethylene or the like other than the fluorine-based monomer may be copolymerized to the extent that the effect of the present invention is not impaired.

A plurality of polymers may be mixed and used as the material of the ultrafiltration membrane, and the polyvinylidene difluoride-based resin is more preferably contained in 50 wt % or more, and particularly preferably contained in 60 wt % or more, when the weight of the ultrafiltration membrane is 100%.

In the ultrafiltration membrane containing the polyvinylidene difluoride-based resin, when the surface is measured by an ATR method (attenuated total reflection method), a ratio (Ha/HB) of an a-type structure crystal (Ha) to a β-type structure crystal (HR) in a crystal portion of the polyvinylidene difluoride-based resin is preferably 0 or more and 0.50 or less. Here, as the crystal structure of the polyvinylidene difluoride-based resin, three structures, a-type, β-type, and y type having an extremely small amount of existence, are known. Among them, the β-type structure crystal has a planar zigzag structure of TTTT, and dipole moments are arranged in the same direction. The membrane surface has a large number of electron-donating components and has polarity. Therefore, the interaction with water molecules, which also have polarity, is strong, and conversely, the organic substance is hardly adsorbed. When Hu/H is 0 to 0.50, excellent fouling resistance to the organic substance can be exhibited. As the ratio (Hu/HR) of the α-type structure crystal (Ha) to the β-type structure crystal (HB) in the crystal portion of the polyvinylidene difluoride-based resin, the ratio of the α-type structure crystal to the β-type structure crystal can be calculated, based on a peak height (Ha) of a signal of the α-type structure crystal appearing at a position of 763 cm⁻¹ and a peak height (HB) of a signal of the β-type structure crystal appearing at 840 cm⁻¹ in a spectrum of an IR spectrum obtained by the ATR method, by using the following formula (3). Ha/H is more preferably 0.25 or more and 0.40 or less, and still more preferably 0.30 or more and 0.40 or less.

$$Ratio of α - type structure crystal / β - type structure crystal = {H}_{α} / {H}_{β} \qquad Formula ( 3 )$$

When the pure water permeability of the ultrafiltration membrane is 0.25 m³/m²/h/50 kPa or more and 1.2 m³/m²/h/50 kPa or less, filtration operation is easily performed at a relatively low pressure even for a filtration raw liquid that easily makes the membrane fouling, and the fouling component is not pressed against the membrane surface at a high pressure. Therefore, adsorption and blocking of the ultrafiltration membrane are inhibited, and a sufficient permeated liquid is easily obtained even in filtration of a filtration raw liquid having a large amount of fouling components. The pure water permeability is more preferably 0.30 m³/m²/h/50 kPa or more and 1.2 m³/m²/h/50 kPa or less, and still more preferably 0.40 m³/m²/h/50 kPa or more and 1.2 m³/m²/h/50 kPa or less.

When the ultrafiltration membrane has a hollow fiber shape and a surface elastic modulus of an outer side of the hollow fiber membrane is 200 MPa or more, it is easy to inhibit the abrasion of the hollow fiber membrane and reduce the decrease in the removal rate. Accordingly, it is easy to stably maintain a high removal rate without lowering the removal rate due to abrasion. The surface elastic modulus of the outer surface of the hollow fiber membrane is an index of a restoring force of the membrane against indentation, and irreversible deformation is less likely to occur as the restoring force is increased. When irreversible deformation, that is, plastic deformation occurs, a shape of a pore of the hollow fiber membrane changes, and a component to be removed by the hollow fiber membrane is likely to leak into the permeated liquid. It has been found that by using a hollow fiber membrane having a high surface elastic modulus, it is easy to inhibit abrasion by a strong restoring force even when the suspended substance comes into contact with the hollow fiber membrane and rubs the hollow fiber membrane to cause abrasion thereof. The surface elastic modulus is preferably 230 MPa or more, more preferably 250 MPa or more, and particularly preferably 300 MPa or more in order to exert a sufficient restoring force when the suspended substance is pressed to the membrane, and the surface elastic modulus is preferably 450 MPa or less, more preferably 400 MPa or less, and particularly preferably 350 MPa or less in order to impart toughness to the membrane and inhibit cracking when the hollow fiber membrane collides with the suspended substance.

The surface elastic modulus can be tested and calculated according to a method based on ISO14577 using a commercially available nanoindenter. In the case where the hollow fiber membrane is measured, the dried hollow fiber membrane is fixed to a metal or glass plate and is measured at room temperature with the maximum load being 0.1 mN, the application time being 15 seconds, and the maximum load holding time being 30 seconds, and the surface elastic modulus is calculated using the Poisson's ratio of the main component constituting the outer surface of the hollow fiber membrane in an indentation depth range of 0.4 μm or more and 0.8 μm or less. The Poisson's ratio is 0.35 in the case of a polyvinylidene difluoride-based resin, 0.37 in the case of polysulfone, 0.40 in the case of polyethersulfone, and 0.30 in the case of cellulose acetate. Here, among the components constituting the hollow fiber membrane, a component having a weight fraction of 50% or more is defined as a main component. The main component can be determined by a known technique using a general composition analyzer. Examples thereof include IR, NMR, and ICP. The surface elastic modulus is determined by measuring the surface elastic modulus five times for the same hollow fiber membrane while changing a measurement location, further measuring three different hollow fiber membranes, and calculating the average of all the measurement values.

It is preferable that the ultrafiltration membrane has a hollow fiber shape, a crystalline polymer resin containing polyvinylidene difluoride is a main component, and the crystallinity of the polymer resin constituting the hollow fiber membrane is 30% or more within 50 μm from an outer surface of the hollow fiber membrane. The crystallinity of 30% or more is preferable because deformation of the pores is easily inhibited, and the suspended substance easily bounces off the membrane surface when the suspended substance collides with the hollow fiber membrane. In order to inhibit deformation of the pores and enhance bounce-off of the suspended substance, the crystallinity is more preferably 35% or more and still more preferably 40% or more. However, when the crystallinity exceeds 80%, the flexibility of the hollow fiber membrane is lost, for example, the hollow fiber membrane is likely to be broken by operation such as cross-flow operation or the like, and therefore, the crystallinity is preferably 80% or less.

In the case where the crystallinity of the hollow fiber membrane is determined, the crystallinity can be calculated based on a measurement result of a differential scanning calorimeter (hereinafter referred to as DSC). A section within 50 μm from the outer surface of the hollow fiber membrane used for measuring the crystallinity is collected and used with a commercially available freezing microtome. In the microtome, the hollow fiber membrane is moved by a certain movement distance and then cut by bringing a blade into contact with the hollow fiber membrane. A blade is placed in a direction parallel to the surface of the hollow fiber membrane. First, the hollow fiber membrane is cut once by bringing the hollow fiber membrane close to the blade at an interval of the movement distance of 5 μm. Thereafter, a surface portion having a thickness of 40 μm to 45 μm can be collected from the surface by further cutting the hollow fiber membrane once with the movement distance being 40 μm.

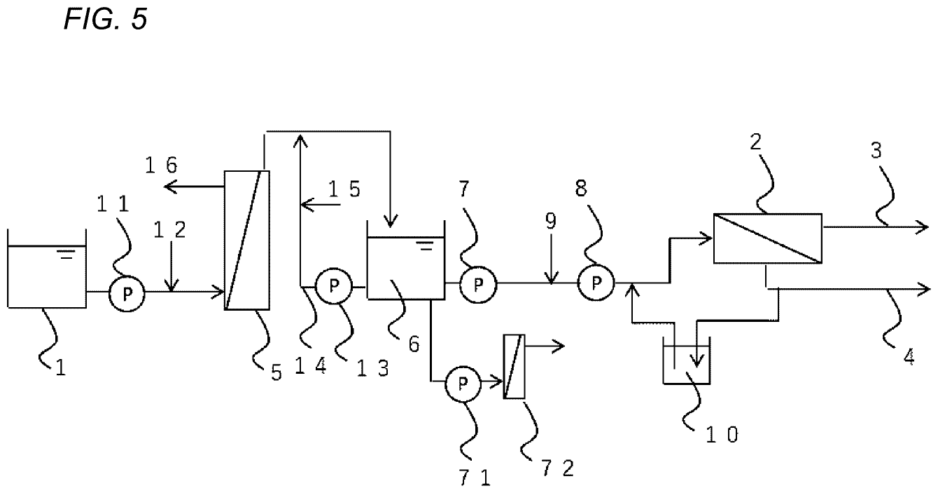

The biopolymer concentration is generally measured by the above-described LC-OCD method, but as shown in FIG. 5, a filtration resistance increase degree (δA) when the feed water for semipermeable membrane 6 is filtered through an ultrafiltration membrane 72 having a removal rate of dextran having a weight average molecular weight of 40,000 Da of 60% or more and 95% or less may be used as an alternative to the biopolymer concentration. It is preferable to use the filtration resistance increase degree (δA) of the ultrafiltration membrane as an index because operation control based on online measurement and measurement results is easy. The ultrafiltration membrane 72 is a membrane having a high biopolymer removal rate, whereas a low-molecular-weight component is allowed to be permeated. The feed water for semipermeable membrane is water subjected to the pretreatment in advance, and thus the feed water for semipermeable membrane does not contain a solid component such as a suspended substance. Therefore, the filtration resistance increase degree (δA) when the feed water for semipermeable membrane 6 is filtered by the ultrafiltration membrane 72 is derived from the biopolymers, and therefore, δA is an alternative index of the biopolymer concentration.

δA is determined, for example, as follows. When the time until a filtrated water in a predetermined amount W1 is obtained by supplying the feed water for semipermeable membrane to the ultrafiltration membrane at a predetermined filtration pressure P1 and performing filtration is defined as t1, the filtration resistance R1 [1/m] is determined as in the following formula (4).

$$( Filtration resistance R 1 ) = ( filtration pressure P 1 ) \times ( time t 1 required for filtration ) \times ( membrane area A ) / \{ ( viscosity μ of raw water ) \times ( predetermined amount W 1 ) \} \qquad Formula ( 4 )$$

When the filtration is continuously performed, the filtration resistance R1 is continuously obtained. The total filtrated water amount per unit membrane area is plotted on a horizontal axis, R1 is plotted on a vertical axis, and the rate of change (slope) of the filtration resistance with respect to the total filtrated water amount per unit membrane area is defined as the filtration resistance increase degree (δA). The filtration flow rate q1 may be measured by a flowmeter or the like, and the filtration resistance R1 may be determined from the following formula (5).

$$( Filtration resistance R 1 ) = ( filtration pressure P 1 ) \times ( membrane area A ) / \{ ( viscosity μ of raw water ) \times ( filtration flow rate q 1 ) \} \qquad Formula ( 5 )$$

In the case where an ultrafiltration membrane having a removal rate of dextran having a weight average molecular weight of 40,000 Da of 60% or more and 95% or less is used in the pretreatment unit 5, the filtration resistance increase degree (δA) when the feed water for semipermeable membrane 6 is caused to flow back to the ultrafiltration membrane may be used as an alternative index of the biopolymer concentration. As shown in FIG. 5, in the case where the ultrafiltration membrane is used in the pretreatment unit 5, a function of performing backflow cleaning using filtrated water (feed water for semipermeable membrane) of the ultrafiltration membrane is normally provided in order to clean and remove the fouling component adhering to the ultrafiltration membrane when filtration is performed. Therefore, there is no need to add a new device for measuring δA.

δA can be determined by using the filtration resistance R1 calculated by the above formula (5) from the transmembrane differential pressure (filtration pressure) when the backflow cleaning is performed. However, in the normal operation of the ultrafiltration membrane, backflow cleaning is performed for 30 seconds to 60 seconds after filtration is performed for 20 minutes to 30 minutes, and the transmembrane differential pressure during the backflow cleaning period includes a resistance derived from a fouling component remaining in the membrane, and therefore, it may be difficult to accurately measure δA. Therefore, during the measurement of δA, it is desirable to determine δA based on data of a period in which an increase in the transmembrane differential pressure is observed after the period of the backflow cleaning is extended more than usual and the removal of the fouling remaining in the membrane is completed. In addition, in the operation of the ultrafiltration membrane, a step of removing fouling in the membrane by injecting a chemical liquid 15 (sodium hypochlorite or the like) about 1 time to 2 times per day to perform backflow cleaning, and immersing the ultrafiltration membrane in the chemical liquid for about 20 minutes is also often provided, but backflow cleaning may be performed after the completion of the chemical liquid backflow cleaning step to determine δA.

In the present invention, when δA determined by the above method exceeds a predetermined threshold, a condition of at least one of the pretreatment step, the cleaning step, and the sterilizing agent addition step is added or reinforced, and the threshold of δA is preferably 2.5×10⁻¹²/m². Accordingly, the progress of fouling of the semipermeable membrane can be efficiently inhibited.

### EXAMPLES

Hereinafter, the present invention will be specifically described, but the present invention is not limited only to Examples of the present invention.

### Reference Example 1

A hollow fiber porous membrane A including a support membrane obtained by the following preparation method was obtained.

A PVDF (KF1300, weight average molecular weight: 350,000 Da; manufactured by Kureha Corporation) of 38 mass % and γ-butyrolactone of 62 mass % were mixed and dissolved at 160° C. to prepare a support membrane raw liquid. The support membrane raw liquid was discharged from a double pipe spinneret together with a 85 mass % aqueous γ-butyrolactone solution as a hollow portion forming liquid. The discharged support membrane raw liquid was coagulated in a cooling bath containing 85 mass % aqueous γ-butyrolactone solution at a temperature of 20° C. and disposed below 30 mm of the spinneret, and a hollow fiber-shaped support membrane having a spherical structure was prepared.

PVDF (Kynar® 710, weight average molecular weight: 180,000 Da; manufactured by Arkema Inc.) of 12 mass %, cellulose diacetate (CA-398-3; manufactured by Eastman Corporation) of 4.0 mass %, cellulose triacetate (CA-436-80S; manufactured by Eastman Corporation) of 4.0 mass %, and N-methyl-2-pyrrolidone of 80.0 mass % were mixed, followed by stirring at 120° C. for 4 hours, and a polymer solution was prepared.

Next, the polymer solution was uniformly applied to an outer surface of the hollow fiber-shaped support membrane at 10 m/min (thickness: 50 μm). The support membrane to which the polymer solution had been applied was drawn at 10 m/min, and after 1 second from the application, the support membrane was passed through and coagulated in a coagulation bath containing distilled water at 25° C. for 10 seconds to form a porous membrane A having a three-dimensional network structure. As a result of evaluating the obtained porous membrane A, the removal rate of dextran having a weight average molecular weight of 200,000 Da was 94%, the removal rate of dextran having a weight average molecular weight of 40,000 Da was 55%, the number of surface pores was 196 pores/μm², the average value of the surface pore size was 15 nm, and the value X obtained by dividing the number of surface pores by the average value of the surface pore sizes was 13 pores/μm²/nm. In addition, the ratio of a-type structure crystal/β-type structure crystal=H_{α}/H_{β} was 1.0, the pure water permeability was 0.41 m³/m²/h/50 kPa, the surface elastic modulus was 150 MPa, and the crystallinity was 11%.

The removal rate of dextran having a weight average molecular weight of 200,000 Da was determined by the following procedure. Dextran (manufactured by Aldrich; weight average molecular weight: 200,000 Da) was mixed with 1000 ppm distilled water to prepare an aqueous dextran solution. The prepared aqueous dextran solution was supplied to the porous membrane at 25° C. so as to form a transmembrane differential pressure of 10 kPa, and cross-flow filtration was performed at a cross-flow linear velocity of 1.0 m/sec to sample the permeated liquid. Here, the cross-flow linear velocity is a value obtained by dividing a flow rate of the raw liquid to be filtrated in a direction perpendicular to a filtration direction by a cross-sectional area of a flow channel of the flow. The transmembrane differential pressure is a difference between a pressure on the filtration raw liquid side and a pressure on the permeated liquid side across the porous membrane. The aqueous dextran solution (raw liquid) supplied to the porous membrane was sampled at a timing of sampling the permeated liquid. The refractive index of the permeated liquid and the refractive index of the raw liquid were measured, and the removal rate T was determined based on the following formula (2).

$$Dextran removal rate T ( \% ) = \{ ( refractive index of raw liquid ) - ( refractive index of permeated liquid ) \} / ( refractive index of raw liquid ) \times 100 \qquad Formula ( 2 )$$

The removal rate of dextran having a weight average molecular weight of 40,000 Da was measured by the same test method as that of the removal rate of dextran having a weight average molecular weight of 200,000 Da, except that dextran to be used was dextran (manufactured by Aldrich; weight average molecular weight: 40,000 Da).

The porous membrane was vacuum-dried overnight at 25° C., and then observed at a magnification of 30,000 to 100,000 times using an SEM (S-5500, manufactured by Hitachi High-Technologies Corporation). An image obtained by using the SEM to observe the surface of the porous membrane was binarized using free software “ImageJ”. During binarization, after Create Background was performed by Subtract Background with 1 pixel, Condition: Renyi Entropy was selected in Threshold (threshold for binarization). In the obtained binarized images, an area of each pore was determined by selecting Area in Analyze Particles, and the diameter calculated on the assumption that each pore was a circle was defined as the surface pore size. When the average value of the surface pore sizes was determined, the pore sizes of one thousand or more pores were averaged to determine the average value. The number of pores was divided by an area of an observed region to obtain the number of pores per unit area.

An IR spectrum of the ultrafiltration membrane surface was measured at a resolution of 8 cm⁻¹ by the ATR method (attenuated total reflection method) using IRTracer-100 manufactured by Shimadzu Corporation. A ratio of the α-type structure crystal to the β-type structure crystal was calculated, based on the peak height (Ha) of the signal of the α-type structure crystal appearing at the position of 763 cm⁻¹ and the peak height (HB) of the signal of the β-type structure crystal appearing at 840 cm⁻¹ in the obtained spectrum, by using the following formula (3).

$$Ratio of α - type structure crystal / β - type structure crystal = {H}_{α} / {H}_{β} \qquad Formula ( 3 )$$

A section within 50 μm from the outer surface of the hollow fiber-shaped ultrafiltration membrane used for measuring the crystallinity was collected and used with a commercially available freezing microtome (Jung CM3000; manufactured by Leica Corporation). The hollow fiber membrane immersed in distilled water was frozen at −20° C. using the freezing microtome (Jung CM3000; manufactured by Leica Corporation), and a blade was disposed in a direction parallel to the surface of the hollow fiber membrane. First, the hollow fiber membrane was cut once by bringing the hollow fiber membrane close to the blade at an interval of the movement distance of 5 μm. Thereafter, a hollow fiber membrane section having a thickness of 40 μm to 45 μm was collected from the surface by further performing cutting once with a movement distance of 40 μm. When the section was set in a DSC (DSC6200 manufactured by SEIKO Corporation) and the temperature was increased from room temperature to 300° C. at 5° C./min, an endothermic peak of each polymer resin was regarded as heat of fusion, and the amount of heat was divided by the amount of heat of fusion of a complete crystal of the polymer resin to calculate the crystallinity as a percentage. For example, regarding the polyvinylidene difluoride-based resin, an endothermic peak observed in a range of 100° C. to 190° C. was regarded as the heat of fusion of the polyvinylidene difluoride-based resin, and the amount of heat was divided by 104.6 J/g, which is the amount of heat of fusion of a complete crystal of the polyvinylidene difluoride-based resin, to calculate the crystallinity as a percentage.

In the measurement of the surface elastic modulus of the hollow fiber-shaped ultrafiltration membrane, a Berkovich indenter made of diamond was attached to Nano Indenter SA2 manufactured by KLM Corporation, and a test of applying and removing a compression load was performed by a method according to ISO14577 in the atmosphere at room temperature. The dried hollow fiber membrane was cut in a length of about 1 cm, fixed onto a square metal plate having a side length of 1 cm with a double-sided tape, and used for the measurement. The measurement was performed in the atmosphere at room temperature with the maximum load being 0.1 mN, the application time being 15 seconds, and the maximum load holding time being 30 seconds, and the surface elastic modulus was calculated with a Poisson's ratio of 0.35 in the case where the hollow fiber membrane containing a polyvinylidene difluoride-based resin as a main component was measured. Different portions were indented with N=5, and the surface elastic modulus was calculated in a range of indentation depth of 0.4 μm to 0.8 μm. The same measurement was performed using three different hollow fiber membranes, and an average value of all the measurement values was used as a measurement result of the surface elastic modulus.

The pure water permeability of the hollow fiber-shaped ultrafiltration membrane was measured as follows: preparing a small module having a length of about 10 cm and made up of about 1 to 10 hollow fiber membranes; feeding distilled water from a surface A and filtering the total amount of distilled water under conditions of a temperature of 25° C. and a filtration differential pressure of 18.6 kPa; and converting a value obtained by measuring the permeated water amount (m³) for a certain period of time into a value per unit time (hr), unit effective membrane area (m²), and 50 kPa to calculate the pure water permeability.

### Reference Example 2

A porous membrane B was obtained in the same manner as in membrane production in Reference Example 1, except that the composition ratios of the polymer solution were changed to PVDF (Kynar® 710, weight average molecular weight: 180,000 Da; manufactured by Arkema Inc.) of 12 mass %, cellulose diacetate (CA-398-3; manufactured by Eastman Corporation) of 4.8 mass %, cellulose triacetate (CA-436-80S; manufactured by Eastman Corporation) of 2.4 mass %, N-methyl-2-pyrrolidone of 68.7 mass %, and 2-pyrrolidone of 12.1 mass %.

As a result of evaluating the obtained porous membrane B in the same manner as in Reference Example 1, the removal rate of dextran having a weight average molecular weight of 200,000 Da was 96%, the removal rate of dextran having a weight average molecular weight of 40,000 Da was 71%, the number of surface pores was 444 pores/μm², the average value of the surface pore sizes was 7.2 nm, and the value X obtained by dividing the number of surface pores by the average value of the surface pore sizes was 62 pores/μm²/nm. In addition, the ratio Ha/H of the a-type structure crystal/B-type structure crystal was 0.37, the pure water permeability was 0.43 m³/m²/h/50 kPa, the surface elastic modulus was 310 MPa, and the crystallinity was 49%.

### Reference Example 3

The hollow fiber support membrane obtained in the membrane production of Reference Example 1 was defined as a porous membrane C.

As a result of evaluating the obtained porous membrane C in the same manner as in Reference Example 1, the removal rate of dextran having a weight average molecular weight of 200,000 Da was 48%, the number of surface pores was 0.1 pores/μm², the average value of the surface pore sizes was 1230 nm, and the value X obtained by dividing the number of surface pores by the average value of the surface pore sizes was 8×10⁻⁵ pores/μm²/nm. The pure water permeability was 1.3 m³/m²/h/50 kPa, and the surface elastic modulus was 130 MPa.

### Example 1

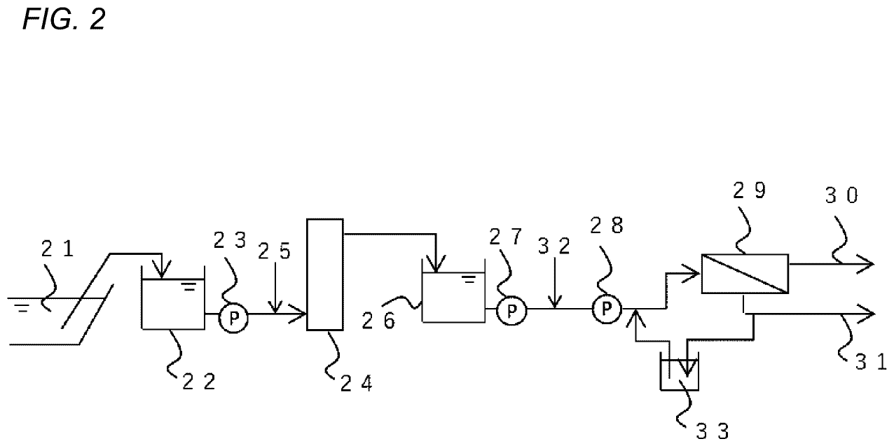

In a seawater desalination plant A, seawater was treated by a treatment method as shown in FIG. 2. First, seawater 21 was taken in and stored in a seawater storage tank 22. Next, the seawater was supplied to a sand filtration tank 24 (filtration area: 17 m², filtration layer height: 1.5 m, filtration medium: sand (average pore size: 0.6 mm)) by a supply pump 23, and filtration was performed to perform pretreatment of the seawater. A filtration rate was 10 m/h, and backwashing and air cleaning were performed once a day. In addition, a coagulant 25 (ferric chloride: 3 mg-Fe/L) was added in a previous stage of the sand filtration tank. The seawater pretreated according to the coagulation and sand filtration method was temporarily stored in a feed water for semipermeable membrane storage tank 26, then fed to a high-pressure pump 28 by a water feeding pump 27, and filtered by a semipermeable membrane 29 by pressurizing with the high-pressure pump to obtain permeated water 30 and concentrated water 31.

The semipermeable membrane was a spiral-type reverse osmosis membrane having a polyamide as a membrane material, a salt rejection rate of 99.8%, and a membrane area of 37 m². The operation was performed at a membrane filtration flux of 14 L/m²/hr and a recovery rate of 37%. The recovery rate is calculated by flow rate of permeated water/(flow rate of permeated water+flow rate of concentrated water)×100. In addition, in the operation of the semipermeable membrane, a pressure difference between the feed water for semipermeable membrane and the concentrated water (hereinafter referred to as an operation differential pressure) was monitored, and a change in operation performance was observed. A sterilizing agent 32 can be added between the water feeding pump and the high-pressure pump. A pipe line for introducing a cleaning chemical 33 is provided between the high-pressure pump and the semipermeable membrane so that the chemical cleaning can be performed. The cleaning chemical was led out from the middle of the concentrated water pipe so as to perform circulating cleaning.

In the operation of the plant A, the concentration of the biopolymer in the feed water for semipermeable membrane was periodically measured by the LC-OCD method. Then, a period in which the biopolymer concentration exceeded 75 μgC/L was regarded as a period in which the biofouling potential was high, and flushing cleaning with feed water for semipermeable membrane was periodically performed as addition of the conditions of the cleaning step. Specifically, the high-pressure pump was temporarily stopped, filtration was stopped, only the water feeding pump was operated, and cleaning was performed for 30 minutes to 60 minutes. After the cleaning, the high-pressure pump was restarted, and the operation was restarted. The period in which the concentration of the biopolymer exceeded 75 μgC/L was about 3 months in total, but the flushing cleaning was performed once a week in this period. When such an operation is performed, the operation differential pressure increase in one year in the plant A was within 10% of the initial differential pressure, and the operation was able to be performed without performing chemical cleaning.

### Example 2

In another line of the plant A, a sterilizing agent was added as addition of the conditions of the sterilizing agent addition step, instead of performing the flushing cleaning during the period in which the biopolymer concentration of the feed water for semipermeable membrane exceeded 75 μgC/L. Specifically, a DBNPA was added for 1 hour once every two days so as to have a final concentration of 10 ppm. When such an operation is performed, in this line, the operation differential pressure increase in one year in the plant A was within 10% of the initial differential pressure, and the operation was able to be performed without performing chemical cleaning.

### Example 3

In another line of the plant A, the biopolymer concentration of the concentrated water was periodically measured, and during a period in which the biopolymer concentration exceeded 75×1/(1−R) μgC/L (R was a recovery rate and the recovery rate in the plant A was 37% and thus R=0.37), a sterilizing agent was added and operation was performed in the same manner as in Example 2 as addition of the conditions of the sterilizing agent addition step. When such an operation is performed, in this line, the operation differential pressure increase in one year in the plant A was within 10% of the initial differential pressure, and the operation was able to be performed without performing chemical cleaning.

### Example 4

In another line of the plant A, when the biopolymer concentration of the feed water for semipermeable membrane was measured periodically, the biopolymer concentration was around 65 μgC/L at the beginning of the operation. However, the biopolymer concentration was increased to about 90 μgC/L for a certain period, and therefore, the addition concentration of ferric chloride added as the coagulant 25 to the raw water before entering the sand filtration tank 24 was increased to reinforce the conditions of the pretreatment step.

First, the addition concentration of ferric chloride was increased by 1 mg-Fe/L (0.07 times the excess from 75 μgC/L) (that is, the addition concentration was 4 mg-Fe/L), and the biopolymer concentration of the feed water for semipermeable membrane was not lower than 75 μgC/L. Next, when the addition concentration of ferric chloride was increased by 2 mg-Fe/L (0.13 times the excess from 75 μgC/L) (that is, the addition concentration was 5 mg-Fe/L), the biopolymer concentration of the feed water for semipermeable membrane was lower than 75 μgC/L although the removal rate of suspended substances in sand filtration was slightly decreased, and thus the operation was continued under this condition. Thereafter, since the biopolymer concentration of the feed water for semipermeable membrane decreased to 40 μgC/L, the addition concentration of the coagulant returned to the original concentration of 3 mg-Fe/L, and as a result, the biopolymer concentration of the feed water for semipermeable membrane was around 60 μgC/L, and thus the operation was continued as it is. Thereafter, when the biopolymer concentration of the feed water for semipermeable membrane exceeded 75 μgC/L, ferric chloride having a concentration of 0.1 times or more and 0.33 times or less the excess from 75 μgC/L was additionally added, so that the operation differential pressure increase in one year was within 15% of the initial differential pressure, and the operation was able to be performed without performing chemical cleaning in this line. An average removal rate of the biopolymer in the pretreatment during the period in which the conditions of the pretreatment step were not reinforced was about 50%.

### Example 5

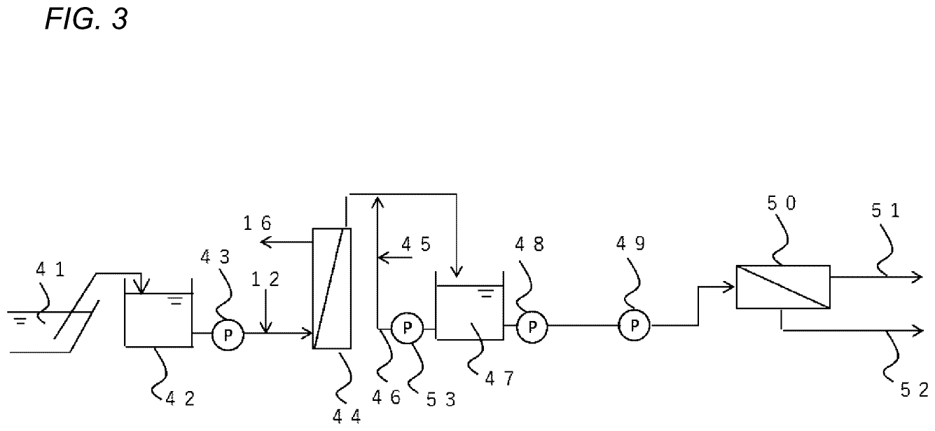

In another line of the plant A, seawater was treated by a treatment method as shown in FIG. 3. First, seawater 41 was taken in and stored in a seawater storage tank 42. Next, the seawater was supplied to a microfiltration membrane 44 by a supply pump 43 and filtered to perform pretreatment of the seawater. The microfiltration membrane is the porous membrane C shown in Reference Example 3. The membrane filtration flux was 1.0 m/d, and backflow cleaning and air cleaning (physical cleaning) were performed once every 20 minutes. In addition, sodium hypochlorite 45 was injected into backflow cleaning water 46 once a day so as to have a final concentration of 300 mg/L, and the backflow cleaning with a chemical liquid was carried out. The pretreated seawater was temporarily stored in a feed water for semipermeable membrane storage tank 47, then fed to a high-pressure pump 49 by a water feeding pump 48, and filtered by a semipermeable membrane 50 by pressurizing with the high-pressure pump to obtain permeated water 51 and concentrated water 52.

The semipermeable membrane was a spiral-type reverse osmosis membrane having a polyamide as a membrane material, a salt rejection rate of 99.8%, and a membrane area of 37 m². The operation was performed at a membrane filtration flux of 14 L/m²/hr and a recovery rate of 37%. In the operation of the semipermeable membrane, the operation differential pressure was monitored, and a change in operation performance was observed.

In the operation of this line of the plant A, as in the case of Example 4, when the biopolymer concentration of the feed water for semipermeable membrane exceeded 75 μgC/L, an operation of adding ferric chloride that was 0.1 times or more and 0.33 times or less the excess from 75 μgC/L was performed as addition of the conditions of the pretreatment step. However, for the membrane pretreatment, no ferric chloride was added when the biopolymer concentration of the feed water for semipermeable membrane did not exceed 75 μgC/L. As a result, in this line, the operation differential pressure increase in one year was within 10% of the initial differential pressure, and the operation was able to be performed without performing chemical cleaning. In addition, the removal rate of the suspended substance in the pretreatment was always stable for the membrane pretreatment. The average removal rate of the biopolymer in the pretreatment during the period in which the addition of the conditions of the pretreatment step was not performed was about 50%.

### Example 6

In another line of the plant A, the pretreatment was performed by changing the microfiltration membrane used in the pretreatment to the ultrafiltration membrane which is the porous membrane A shown in Reference Example 1, and as in the case of Example 5, when the biopolymer concentration of the feed water for semipermeable membrane exceeded 75 μgC/L, an operation of adding ferric chloride that was 0.1 times or more and 0.33 times or less the excess from 75 μgC/L was performed as addition of the conditions of the pretreatment step. As a result, in this line, the operation differential pressure increase in one year was within 10% of the initial differential pressure, and the operation was able to be performed without performing chemical cleaning. In addition, the average removal rate of the biopolymer in the pretreatment during the period in which the addition of the conditions of the pretreatment step was not performed was about 70%, and the removal rate was improved as compared with the case of Example 5. Therefore, the amount of the coagulant to be added was able to be reduced to ¼ in one year.

### Example 7

In another line of the plant A, the pretreatment was performed by changing the microfiltration membrane used in the pretreatment to the ultrafiltration membrane which is the porous membrane B shown in Reference Example 2, and as in the case of Example 5, when the biopolymer concentration of the feed water for semipermeable membrane exceeded 75 μgC/L, an operation of adding ferric chloride that was 0.1 times or more and 0.33 times or less the excess from 75 μgC/L was performed as addition of the conditions of the pretreatment step. As a result, in this line, the operation differential pressure increase in one year was within 10% of the initial differential pressure, and the operation was able to be performed without performing chemical cleaning. In addition, the average removal rate of the biopolymer in the pretreatment during the period in which the addition of the conditions of the pretreatment step was not performed was about 90%, and the removal rate was further improved as compared with the case of Example 5. Therefore, the amount of the coagulant to be added was able to be reduced to 1/10 in one year.

### Example 8

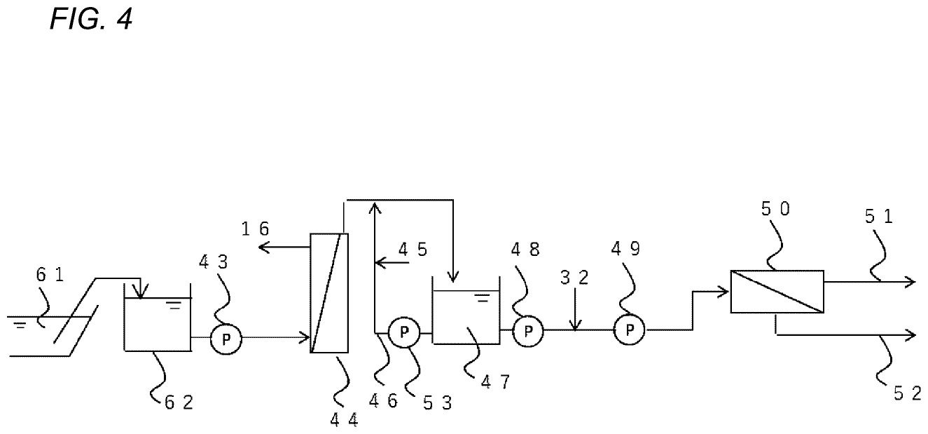

In a sewage reuse plant B, treatment of sewage secondary treatment water was performed according to a treatment method as shown in FIG. 4. First, sewage secondary treatment water 61 was taken in and stored in a sewage secondary treatment water storage tank 62. Next, the sewage secondary treatment water was supplied to an ultrafiltration membrane 44 by the supply pump 43 and filtered to perform pretreatment of the sewage secondary treatment water. This ultrafiltration membrane is the porous membrane B shown in Reference Example 2. The membrane filtration flux was 1.0 m/d, and backflow cleaning and air cleaning (physical cleaning) were performed once every 20 minutes. In addition, the sodium hypochlorite 45 was injected into the backflow cleaning water 46 once a day so as to have a final concentration of 300 mg/L, and the backflow cleaning with a chemical liquid was carried out. The pretreated sewage secondary treatment water was temporarily stored in the feed water for semipermeable membrane storage tank 47, then fed to the high-pressure pump 49 by the water feeding pump 48, and filtered by the semipermeable membrane 50 by pressurizing with the high-pressure pump to obtain the permeated water 51 and the concentrated water 52.

The semipermeable membrane was a spiral-type reverse osmosis membrane having a polyamide as a membrane material, a salt rejection rate of 99.8%, and a membrane area of 37 m². The operation was performed at a membrane filtration flux of 14 L/m²/hr and a recovery rate of 75%. In the operation of the semipermeable membrane, the operation differential pressure was monitored, and a change in operation performance was observed. The sterilizing agent 32 can be added between the water feeding pump and the high-pressure pump.

In the operation of the plant B, the concentration of the biopolymer in the feed water for semipermeable membrane was periodically measured by the LC-OCD method. Then, a period in which the biopolymer concentration exceeded 75 μgC/L was regarded as a period in which the biofouling potential was high, and a sterilizing agent was added as addition of the conditions of the sterilizing agent addition step. Specifically, the DBNPA was added for 1 hour once every two days so as to have a final concentration of 10 ppm. When such an operation is performed, in this line, the operation differential pressure increase in one year was within 10% of the initial differential pressure, and the operation was able to be performed without performing chemical cleaning.

### Example 9

In the operation of the plant A (the pretreatment step was the same as that in Example 5), instead of measuring the biopolymer concentration of the feed water for semipermeable membrane, the filtration resistance increase degree (δA) when the feed water for semipermeable membrane was filtered with the ultrafiltration membrane which is the porous membrane B shown in Reference Example 2 was measured. Specifically, the feed water for semipermeable membrane was supplied to the ultrafiltration membrane (membrane area: 0.18 m²) at a pressure of 60 kPa using a pump, and a filtration flow rate was measured by a flowmeter. The filtration resistance R1 was determined based on the formula (5), and R1 was continuously acquired by continuously performing the filtration. The total filtrated water amount per unit membrane area was plotted on a horizontal axis, R1 was plotted on a vertical axis, and the rate of change (slope) of the filtration resistance with respect to the total filtrated water amount per unit membrane area was determined as the filtration resistance increase degree δA. After δA was acquired, backflow cleaning was performed using RO permeated water in the plant A in order to clean the ultrafiltration membrane, followed by starting the filtration again, and δA was acquired. δA was continuously measured over time by repeating this operation cycle. Then, during a period in which δA exceeds 2.5×10⁻¹²/m², a sterilizing agent was added as addition of the conditions of the sterilizing agent addition step. Specifically, the DBNPA was added for 1 hour once every two days so as to have a final concentration of 10 ppm. When such an operation is performed, in this line, the operation differential pressure increase in one year was within 10% of the initial differential pressure, and the operation was able to be performed without performing chemical cleaning.

### Example 10

In the operation of the plant A (the pretreatment step is the same as that in Example 7), instead of measuring the biopolymer concentration of the feed water for semipermeable membrane, the filtration resistance increase degree (δA) when the feed water for semipermeable membrane was caused to flow back to the ultrafiltration membrane in the pretreatment step was measured. Specifically, after the completion of the physical cleaning step (backflow cleaning and air cleaning) performed once every 20 minutes, only one membrane unit further continued backflow cleaning, and the time-dependent data of the filtration resistance R1 was acquired from the formula (5) after the transmembrane differential pressure starts to increase. The total filtrated water amount per unit membrane area was plotted on the horizontal axis, R1 was plotted on the vertical axis, and the rate of change (slope) of the filtration resistance with respect to the total filtrated water amount per unit membrane area was determined as the filtration resistance increase degree δA. After δA was acquired, filtration of the membrane unit was restarted. By repeating the above steps, &A was continuously measured over time. Then, during a period in which δA exceeds 2.5×10⁻¹²/m², a sterilizing agent was added as addition of the conditions of the sterilizing agent addition step. Specifically, the DBNPA was added for 1 hour once every two days so as to have a final concentration of 10 ppm. When such an operation is performed, in this line, the operation differential pressure increase in one year was within 10% of the initial differential pressure, and the operation was able to be performed without performing chemical cleaning.

### Comparative Example 1

In the operation of the plant A, an operation differential pressure was monitored without measuring the biopolymer concentration of the feed water for semipermeable membrane, and chemical cleaning was performed when the operation differential pressure exceeded a reference value. As a chemical cleaning method, a 0.1% sodium hydroxide solution was used as the cleaning agent 10, placed in a cleaning tank, introduced into the RO pipe from a downstream side of the high-pressure pump 8 by a pump, led out from the middle of the pipe of the concentrated water 4, and circulated for 1 hour to perform cleaning. Thereafter, the membrane was immersed overnight and finally rinsed to complete the cleaning. As a result of the operation, after three months from the start of operation, a rapid increase in the operation differential pressure due to biofouling occurred. Although the chemical cleaning was performed, the operation differential pressure was not sufficiently recovered, and then the operation differential pressure was increased again in one month, so that the membrane was necessarily replaced.

### Comparative Example 2

In another operation period of the plant A, the biopolymer concentration of the feed water for semipermeable membrane was periodically measured according to the LC-OCD method, but the biopolymer concentration of the feed water for semipermeable membrane exceeded 75 μgC/L from the beginning of the operation, and the concentration was changed between 80 μgC/L to 85 μgC/L. Nevertheless, no addition or reinforcement of the pretreatment step, the cleaning step, and the sterilizing agent addition step was carried out, and as a result, after three months from the start of operation, a rapid increase in the operation differential pressure due to biofouling occurred. Although the chemical cleaning was performed, the operation differential pressure was not sufficiently recovered, and then the operation differential pressure was increased again in one month, so that the membrane was necessarily replaced.

### Comparative Example 3

In another operation period of the plant A, the biopolymer concentration of the feed water for semipermeable membrane was periodically measured according to the LC-OCD method, but the period in which the biopolymer concentration was 75 μgC/L or less continued for about 1 year. At this time, when the operation was performed without adding or reinforcing all of the conditions of the pretreatment step, the cleaning step, and the sterilizing agent addition step, the operation differential pressure increase in one year was within 10% of the initial differential pressure, and the operation was able to be performed without performing chemical cleaning.

Although the present invention has been described in detail with reference to specific embodiments, it is apparent to those skilled in the art that various changes and modifications may be made without departing from the spirit and scope of the present invention.

### INDUSTRIAL APPLICABILITY

The present invention can be suitably used when desalination of seawater, brackish water, or the like is performed using a membrane to obtain fresh water, or when sewage treatment water, industrial wastewater, or the like is purified using the membrane to obtain recycled water.

### REFERENCE SIGNS LIST

1: water-to-be-treated
2: semipermeable membrane
3: permeated water
4: concentrated water
5: pretreatment unit
6: feed water for semipermeable membrane
7: water feeding pump
8: high-pressure pump
9: sterilizing agent
10: cleaning agent
11: supply pump
12: coagulant
13: backflow cleaning pump
14: backflow cleaning water
15: chemical liquid
16: backflow cleaning water drainage
21: seawater
22: seawater storage tank
23: supply pump
24: sand filtration tank
25: coagulant
26: feed water for semipermeable membrane storage tank
27: water feeding pump
28: high-pressure pump
29: semipermeable membrane
30: permeated water
31: concentrated water
32: sterilizing agent
33: cleaning chemical
41: seawater
42: seawater storage tank
43: supply pump
44: microfiltration membrane or ultrafiltration membrane
45: sodium hypochlorite
46: backflow cleaning water
47: feed water for semipermeable membrane storage tank
48: water feeding pump
49: high-pressure pump
50: semipermeable membrane
51: filtrated water
52: concentrated water
53: backflow cleaning pump
61: sewage secondary treatment water
62: sewage secondary treatment water storage tank
71: supply pump
72: ultrafiltration membrane

1. A water production method comprising:
a membrane treatment step of treating a feed water for semipermeable membrane with a semipermeable membrane to separate the feed water for semipermeable membrane into a permeated water and a concentrated water; and
at least one of the following steps (A) to (C):
(A) a pretreatment step of obtaining the feed water for semipermeable membrane by pretreating a water-to-be-treated;
(B) a cleaning step of cleaning the semipermeable membrane; and
(C) a sterilizing agent addition step of adding a sterilizing agent to the semipermeable membrane,
wherein when a biopolymer concentration of the feed water for semipermeable membrane exceeds 75 μgC/L, or when a biopolymer concentration of the concentrated water exceeds 75×1/(1−R) μgC/L where R is a recovery rate of the permeated water in the membrane treatment step, an operation condition of at least one of the pretreatment step, the cleaning step, and the sterilizing agent addition step is added or reinforced.

2. The water production method according to claim 1, wherein in the pretreatment step, an operation condition of the pretreatment step is added or reinforced by adding a coagulant.

3. The water production method according to claim 2, wherein when the biopolymer concentration of the feed water for semipermeable membrane exceeds 75 μgC/L and is represented by P [μgC/L], ferric chloride is added as the coagulant at a concentration of (P−75)×0.1 [mg-Fe/L] or more and (P−75)×0.33 [mg-Fe/L] or less.

4. The water production method according to claim 1, wherein the pretreatment step includes a microfiltration membrane method or an ultrafiltration membrane method.

5. The water production method according to claim 4, wherein an ultrafiltration membrane used in the ultrafiltration membrane method has a removal rate of dextran having a weight average molecular weight of 200,000 Da of 55% or more and 99% or less.

6. The water production method according to claim 4, wherein the ultrafiltration membrane used in the ultrafiltration membrane method has a removal rate of dextran having a weight average molecular weight of 40,000 Da of 60% or more and 95% or less.

7. The water production method according to claim 5, wherein the number of surface pores of the ultrafiltration membrane is 200 pores/μm² or more and 2000 pores/μm² or less.

8. The water production method according to claim 5, wherein an average value of surface pore sizes of the ultrafiltration membrane is 5.0 nm or more and 12.0 nm or less.

9. The water production method according to claim 5, wherein a value obtained by dividing the number of surface pores of the ultrafiltration membrane by the average value of surface pore sizes of the ultrafiltration membrane is 30 pores/μm²/nm or more and 100 pores/μm²/nm or less.

10. A water production method comprising:
a membrane treatment step of treating a feed water for semipermeable membrane with a semipermeable membrane to separate the feed water for semipermeable membrane into a permeated water and a concentrated water; and
at least one of the following steps (A) to (C):
(A) a pretreatment step of obtaining the feed water for semipermeable membrane by pretreating a water-to-be-treated;
(B) a cleaning step of cleaning the semipermeable membrane; and
(C) a sterilizing agent addition step of adding a sterilizing agent to the semipermeable membrane,
wherein when a filtration resistance increase degree (OA) at a time of filtrating the feed water for semipermeable membrane with an ultrafiltration membrane having a removal rate of dextran having a weight average molecular weight of 40,000 Da of 60% or more and 95% or less exceeds a predetermined threshold, an operation condition of at least one of the pretreatment step, the cleaning step, and the sterilizing agent addition step is added or reinforced.

11. The water production method according to claim 10, wherein the pretreatment step includes pretreating the water-to-be-treated using an ultrafiltration membrane having a removal rate of dextran having a weight average molecular weight of 40,000 Da of 60% or more and 95% or less, and the operation condition of at least one of the pretreatment step, the cleaning step, and the sterilizing agent addition step is added or reinforced when the filtration resistance increase degree (OA) when the feed water for semipermeable membrane flows back to the ultrafiltration membrane exceeds the predetermined threshold.

12. The water production method according to claim 10 or 11, wherein the threshold of the filtration resistance increase degree (δA) is 2.5×10⁻¹²/m².
